(19) United States
(12) Patent Application Publication
(10) Pub. No.: US 2007/0020430 A1
(43) Pub. Date: Jan. 25, 2007

(54) Production of backing component for carpet products

(76) Inventor: Donald Walker Lees, White, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/452,507

(22) Filed: Jun. 14, 2006

Related U.S. Application Data
(60) Provisional application No. 60/690,256, filed on Jun. 14, 2005.

(51) Int. Cl. B32B 33/00; B32B 3/02; D05C 15/00

(52) U.S. Cl. 428/97; 428/95; 156/72

(57) ABSTRACT

Disclosed are plastic compositions for a carpet backing having from about 5 to about 25% by weight PVC resin, from about 5 to about 25% by weight plasticizer, and from about 50 to about 90% by weight filler. In a preferred embodiment, the plastic composition is about 15% by weight Geon-138, about 15% by weight di-isononyl phthalate, and about 70% by weight fly ash. Also disclosed are methods for forming backings for floorcoverings using the disclosed plastic compositions. In preferred embodiments, a plastic composition is applied through a slot-die directly to the underside of a carpet or alternatively onto a conveyor belt on top of which the carpet or floorcovering may be subsequently positioned.

### CROSS REFERENCE TO RELATED APPLICATION

This application claims benefit of U.S. Provisional Patent Application Ser. No. 60/690,256, filed Jun. 14, 2005, the contents of which are incorporated herein by reference.

### FIELD OF THE INVENTION

This invention relates to compositions, apparatuses, and methods for forming a backing component for carpet products, including carpet tiles.

### BACKGROUND OF THE INVENTION

Carpet products, including carpet tiles, typically have a fiber-containing pile face attached to a primary backing and, attached to the underside of the primary backing, a multi-component secondary backing containing a variety of materials that impart desired physical properties, including weight, stability, stiffness, durability, under-foot comfort, and resistance to cupping and curling, among other properties.

One of the materials conventionally used in carpet tile secondary backing is polyvinyl chloride (“PVC”). See, for example, U.S. Pat. Nos. 4,010,301, 4,010,302, and 5,560,972 that are incorporated herein by reference. As U.S. Pat. No. 5,560,972 explains, such a secondary backing is typically applied as a liquid having a viscosity of approximately 10,000-20,000 centipoise. Column 7, lines 24-39. The liquid is applied to the carpet web or onto a conveyor belt by depositing it in a puddle that is then metered to a desired thickness with a doctor bar or calendar roll.

It is often desirable to incorporate inexpensive fillers (such as fly ash, dirt, etc.) into the backing composition and thereby reduce the unit cost of the composition. Incorporation of these fillers increases the viscosity of the backing composition. However, a doctor bar is not suitable for such high viscosity compositions because it is very difficult precisely to meter such compositions to the desired thickness, and use of a calendar roll with such high viscosity compositions can result in excessive conveyor belt wear and other problems. Thus, simply pouring onto a carpet web or a conveyor belt the composition having filler (and thus a high viscosity) and doctoring or calendar rolling the material to a precise gauge is extremely difficult. This invention provides an alternative apparatus and method for forming carpet backings from compositions having a high filler content whereby the composition is dispensed in a sheet-like form through a slot die.

Extruders have been used to extrude PVC into a sheet-like form. While many types of extruders exist, they all operate in substantially the same way. Solid phase materials (such as plastic powder or solid pellets) are supplied into a cavity in the extruder. Energy is imparted to the solid materials in the cavity to convert them into a phase (semi-solid or liquid) capable of flowing through the extruder die. The energy to effectuate phase change may be imparted by supplying heat to the extruder, increasing the pressure in the extruder, and/or may result simply by shearing of the materials in the extruder cavity.

Extruders, however, are not ideal for extruding materials having a high filler content. Extruders represent a large capital investment and are extremely costly to maintain and repair. The fillers in compositions having high filler content do not melt or otherwise change phase during the extrusion process. These grit-like fillers thus wear excessively on the extruder parts and thus require their frequent replacement, which is extremely costly. Thus, use of extruders with compositions having high filler content is undesirable.

### SUMMARY OF THE INVENTION

This invention addresses the problems of previous backing compositions and methods for forming backing compositions by providing plastic compositions for a carpet backing having from about 5 to about 25% by weight PVC resin, from about 5 to about 25% by weight plasticizer, and from about 50 to about 90% by weight filler. The PVC composition is preferably Geon-138, Geon-121, Formolon-40, VC-216 or combinations thereof, and is more preferably about 15% by weight Geon-138. The plasticizer is preferably di-isononyl phthalate, di-isoheptyl phthalate, di-isoundecyl phthalate or combinations thereof, and is more preferably about 15% by weight di-isononyl phthalate. The filler is preferably fly ash, dirt, calcium carbonate or combinations thereof, and is more preferably about 70% by weight fly ash. The plastic composition preferably has a viscosity of from about 30,000 to about 50,000 centipoise. The plastic composition may be applied as a floorcovering backing and preferably has a thickness of from about 20 to about 75 mils, and more preferably has a thickness of about 25 mils.

Also disclosed are methods for forming a floorcovering by preparing a plastic composition according to the above and forming the plastic composition into a backing layer by preferably feeding the plastic composition through a slot-die. In a preferred embodiment, the plastic composition is prepared in a holding tank and pumped from the holding tank to the slot die with a gear pump or an extruder. In other embodiments, the backing layer exiting the slot-die is positioned directly onto a conveyor belt and a face of the floorcovering is positioned above the backing layer. Additional layers, such as a stabilizing layer, may be positioned between the backing layer and the face. The backing layer exiting the slot-die may also be positioned on the underside of a face of the floorcovering. The disclosed compositions may be used in the backing of a variety of floorcovering products including, but not limited to, vinyl floorcovering and tiles, broadloom carpet, six foot carpet, and carpet tiles.

### BRIEF DESCRIPTION OF THE DRAWINGS

FIG. 1 is a schematic drawing of a preferred embodiment of the apparatus of the present invention.

FIG. 2 is a schematic drawing according to another embodiment of the invention.

FIG. 3 is a schematic drawing according to yet another embodiment of the invention.

FIG. 4 is a schematic drawing according to a further embodiment of the invention.

### DETAILED DESCRIPTION OF THE INVENTION

This invention provides more effective and less expensive compositions, apparatuses and methods for forming a plastic layer component—described herein as a plastisol—of a carpet backing, particularly a carpet tile secondary backing. While the apparatuses and methods of this invention can be used for forming a wide variety of types and thicknesses of plastisols, they are particularly effective for use with compositions having a high filler content. The plastisol according to the present invention is desirably 20 to 75 mils thick, more desirably 20 to 50 mils thick, and most desirably 25 mils thick (i.e. 0.025 inches). The plastisol is formed from the following components:

| Component | Amount by weight |
|---|---|
| PVC resin | 5-25% |
| Plasticizer | 5-25% |
| Filler | 50-90% |

The PVC resin is the plastic component to the plastisol. Suitable PVC resins include: Geon-138 and Geon-121, produced by PolyOne Corporation; Formolon-40, produced by Formosa Plastics Corp.; VC-216, produced by Borden Chemical Co.; and combinations thereof. A particularly preferable PVC resin is Geon-138 in an amount of approximately 15% by weight.

The plasticizer is added to improve the flow and viscosity characteristics of the plastisol. Suitable plasticizers include di-isononyl phthalate, di-isoheptyl phthalate, di-isoundecyl phthalate and combinations thereof. A particularly preferable plasticizer is di-isononyl phthalate in an amount of approximately 15% by weight.

The filler can be any material which allows the amount of plasticizer and/or PVC resin in the plastisol to be reduced, and are usually inexpensive relative to the cost of the plasticizer and PVC resin. Suitable fillers include fly ash, dirt, calcium carbonate and combinations thereof. A particularly preferable filler is fly ash in an amount of approximately 70% by weight.

When mixed, the plastisol can have a viscosity of approximately 30,000 to 50,000 centipoise. Note that while the apparatus and methods of this invention are disclosed for use with a plastisol, they may be used with a variety of other materials, including polyvinylbutyral and highly-filled asphalt-based products, such as those disclosed in U.S. Pat. Nos. 5,030,497 and 5,096,764, the entireties of which are herein incorporated by reference.

The plastic sheet of this invention may be formed by dispensing the plastic material, such as the above-described plastisol, through a slot die having a horizontal slot that may be, for instance, approximately 25 mils in height and approximately 80 inches in width. The slot die is positioned immediately above and/or adjacent a conveyor belt. In a preferred embodiment, the plastic sheet is deposited directly on the conveyor belt, after which optional additional backing components such as a fiberglass scrim and a second coating of PVC resin or plastisol can be, but does not have to be, applied atop the plastic sheet. A carpet web is then positioned directly on top of the plastic sheet or on top of the backing composite to bond thereto. In an alternative embodiment, an upside down carpet web rests on the conveyer belt or other system so that the web advances at the same speed as the exiting plastic sheet, permitting the sheet to lie on and be bonded to the advancing web. Unlike the prior doctoring method described above, the slot die is easily able to form sheets of consistent gauge from compositions having high filler content and thus high viscosities.

In one embodiment of this invention, after mixing, the plastisol of this invention may be placed in a holding tank, from which it is removed by one or more diaphragm pumps that transfer the plastisol from the holding tank to a gear pump that forces the composition through a slot die from which the desired sheet is dispensed. The gear pump imparts a constant pressure to the composition and ensures a smooth, continuous flow of the composition from the slot die. Thus, the sheet exiting the slot die is of consistent gauge. A gear pump and its parts are less expensive than an extruder and thus cheaper to repair should they incur damage from the filler in the composition.

### EXAMPLE 1

In one embodiment of this invention the following materials were mixed utilizing a Nauta mixer (although other mixers, such as a horizontal plow mixer, may be used) to form a plastisol:

| Component | Amount by weight |
|---|---|
| Geon-138 (PVC resin) | 15% |
| di-isononyl phthalate (plasticizer) | 15% |
| Fly ash (filler) | 70% |

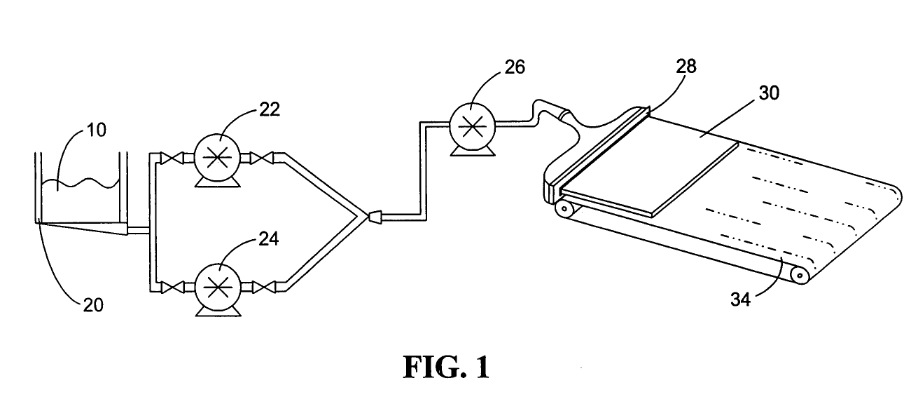

As is illustrated in the schematic diagram of FIG. 1, the plastisol 10 was transferred to a plastisol holding tank 20 illustrated in FIG. 1. Two diaphragm pumps 22 and 24, such as those manufactured by Wilton and preferably having three-inch inlet and outlet ports, were used to transfer the plastisol to a gear pump 26. Gear pump 26, such as the Maag gear pump (model number RX 110/110), had a flow rate of between 70 pounds/minute and 90 pounds/minute and preferably approximately 83 pounds/minute.

### EXAMPLE 2

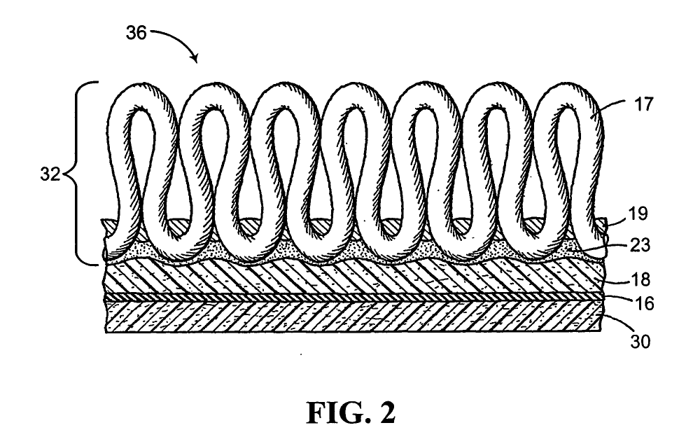

In one embodiment (see FIGS. 1 and 2), gear pump 26 feeds a slot die 28 positioned so that a sheet 30 of plastisol 10 dispensed from the slot die 28 rests on an advancing conveyor 34. Sheet 30 is desirably 20 to 75 mils thick, more desirably 20 to 50 mils, and most desirably approximately 25 mils thick (0.025 inches). After deposit of the sheet 30 on the conveyor 34 (in FIGS. 1 and 2), additional backing structures may be, but do not have to be, introduced on top of the sheet 30. For example, in a preferred embodiment, a stabilizing layer 16 (such as a fiberglass scrim) is positioned on top of the sheet 30, after which another layer of PVC 18 (which may be introduced via another slot die or by a traditional metering process) is applied atop the fiberglass scrim 16. A carpet web 32 is then positioned on top of the upper layer of PVC 18, which serves to bond the carpet web 32 to the underlying backing composite. FIG. 2 illustrates the cross-section of this finished carpet composite 36, having a carpet web or facecloth 32 that includes yarn 17 tufted into a primary backing fabric 19 and secured in place with an adhesive layer 23. Individual carpet tiles may be cut from the resulting finished carpet composite 36 utilizing techniques well known in the industry.

### EXAMPLE 3

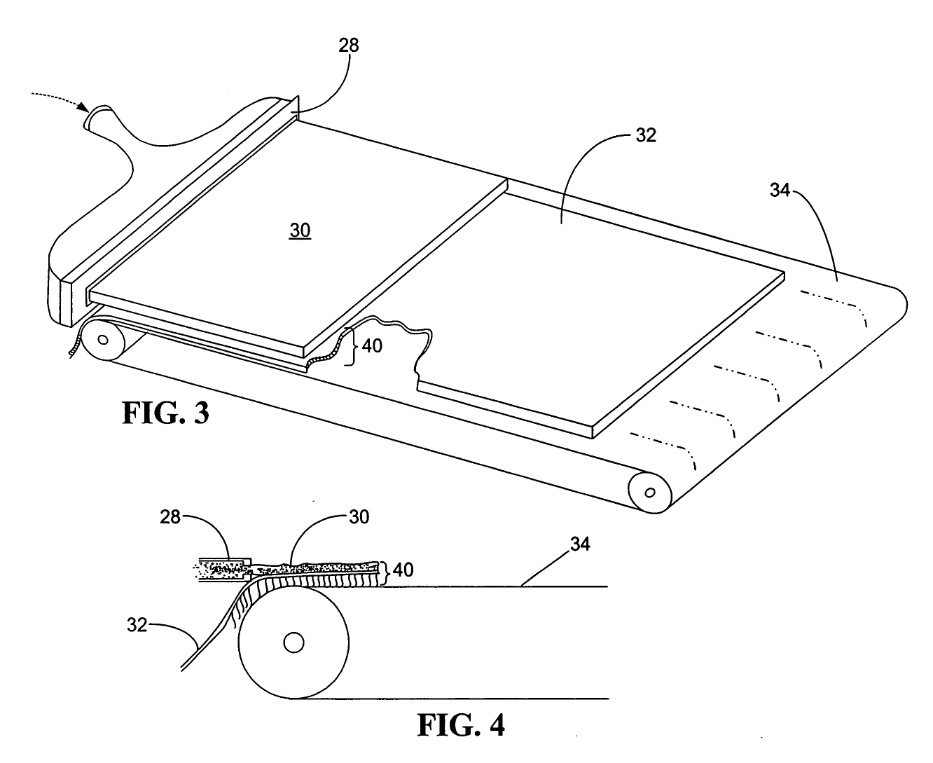

In another embodiment (see FIGS. 3 and 4), gear pump 26 feeds slot die 28 positioned so that the sheet 30 of plastisol 10 dispensed from the slot die 28 rests on an advancing upside down carpet web 32 that itself rests on conveyor 34. Sheet 30 is desirably 20 to 75 mils thick, more desirably 20 to 50 mils and most desirably approximately 25 mils thick (0.025 inches). Deposit of the sheet 30 on the advancing carpet web 32 forms a carpet composite 40 from which individual tiles may be cut utilizing techniques well known in the industry. As with the embodiment of FIG. 2, additional layers of material may be deposited on top of the sheet 30 to form alternative carpet composites than that illustrated in FIG. 4.

### EXAMPLE 4

In another embodiment of this invention the following materials are mixed to form a plastisol:

| Component | Amount by weight |
|---|---|
| Geon-121 (PVC resin) | 10% |
| Formolon-40 (PVC resin) | 10% |
| di-isoheptyl phthalate (plasticizer) | 15% |
| Fly ash (filler) | 65% |

### EXAMPLE 5

In a further embodiment of this invention the following materials are mixed to form a plastisol:

| Component | Amount by weight |
|---|---|
| VC-216 (PVC resin) | 25% |
| di-isononyl phthalate (plasticizer) | 25% |
| calcium carbonate (filler) | 50% |

### EXAMPLE 6

In yet another embodiment of this invention the following materials are mixed to form a plastisol:

| Component | Amount by weight |
|---|---|
| Geon-138 (PVC resin) | 10% |
| di-isoheptyl phthalate (plasticizer) | 10% |
| di-isoundecyl phthalate (plasticizer) | 5% |
| fly ash (filler) | 75% |

### EXAMPLE 7

In yet a further embodiment of this invention the following materials are mixed to form a plastisol:

| Component | Amount by weight |
|---|---|
| Geon-138 (PVC resin) | 5% |
| di-isononyl phthalate (plasticizer) | 5% |
| Fly ash (filler) | 90% |

As will be appreciated by those skilled in the art, the composition of plastisol 10 can be modified by the use of differing amounts of the above-specified components, by substituting, adding or deleting components, and by modifying the above-described processing steps. Such modifications may alter the physical and chemical properties of the plastisol. Notwithstanding such modifications, the sheet-forming methods and apparatus described herein will usually be effective provided that the plastisol (or other plastic paste) is of relatively high viscosity (i.e., has a viscosity in the range of 10,000 to 75,000 centipoise). To realize some of the goals of this invention, such as decreased wear and tear on equipment and reduced cost of the plastisol, a plastisol with a viscosity of between 30,000-50,000 centipoise is particularly desirable. Moreover, the compositions disclosed herein may be used in the backing of a variety of floorcovering products including, but not limited to, vinyl floorcovering and tiles, broadloom carpet, six foot carpet, and carpet tiles.

The foregoing is provided for the purpose of illustrating, explaining and describing embodiments of the present invention. Further modifications and adaptations to these embodiments will be apparent to those skilled in the art and may be made without departing from the spirit of the invention or the scope of the claims.

What is claimed is:

1. A plastic composition for a carpet backing comprising from about 5 to about 25% by weight PVC resin, from about 5 to about 25% by weight plasticizer, and from about 50 to about 90% by weight filler.

2. The plastic composition according to claim 1, wherein the PVC resin is selected from the group consisting of Geon-138, Geon-121, Formolon-40, VC-216 and combinations thereof.

3. The plastic composition according to claim 1, wherein the plasticizer is selected from the group consisting of di-isononyl phthalate, di-isoheptyl phthalate, di-isoundecyl phthalate and combinations thereof.

4. The plastic composition according to claim 1, wherein the filler is selected from the group consisting of fly ash, dirt, calcium carbonate and combinations thereof.

5. The plastic composition according to claim 1, comprising about 15% by weight Geon-138, about 15% by weight di-isononyl phthalate, and about 70% by weight fly ash.

6. The plastic composition according to claim 1, wherein the plastic composition has a viscosity of from about 30,000 to about 50,000 centipoise.

7. A floorcovering backing comprising the plastic composition according to claim 1.

8. The floorcovering backing of claim 7, wherein the plastic composition has a thickness of from about 20 to about 75 mils.

9. The floorcovering backing of claim 8, wherein the plastic composition has a thickness of about 25 mils.

10. A method for forming a floorcovering comprising:
a. preparing a plastic composition by mixing from about 5 to about 25% by weight PVC resin, from about 5 to about 25% by weight plasticizer, and from about 50 to about 90% by weight filler; and
b. forming the plastic composition into a backing layer.

11. The method of claim 10, wherein forming the plastic composition into a backing layer comprises feeding the plastic composition through a slot-die.

12. The method of claim 11, wherein the plastic composition is prepared in a holding tank and pumped from the holding tank to the slot die with a gear pump or an extruder.

13. The method of claim 10, wherein:
a. the PVC resin is selected from the group consisting of Geon-138, Geon-121, Formolon-40, VC-216 and combinations thereof;
b. the plasticizer is selected from the group consisting of di-isononyl phthalate, di-isoheptyl phthalate, di-isoundecyl phthalate and combinations thereof; and
c. the filler is selected from the group consisting of fly ash, dirt, calcium carbonate and combinations thereof.

14. The method of claim 13, wherein the plastic composition comprises about 15% by weight Geon-138, about 15% by weight di-isononyl phthalate, and about 70% by weight fly ash.

15. The method of claim 11, wherein the backing layer exiting the slot-die is positioned directly onto a conveyor belt.

16. The method of claim 15, further comprising positioning a face of the floorcovering above the backing layer.

17. The method of claim 16, further comprising positioning a stabilizing layer between the backing layer and the face.

18. The method of claim 17, wherein the floorcovering comprises carpet.

19. The method of claim 11, wherein the backing layer exiting the slot-die is positioned on the underside of a face of the floorcovering.

20. The method of claim 19, wherein the floorcovering comprises carpet.
